(19) United States
(12) Patent Application Publication
(10) Pub. No.: US 2026/0371119 A1
(43) Pub. Date: Nov. 19, 2026

(54) INDIVIDUAL CELL PERFORMANCE METRIC GENERATION FOR CARRIER AGGREGATION CELL COMBINATIONS

(71) Applicant: T-MOBILE INNOVATIONS LLC, Overland Park, KS (US)

(72) Inventor: John Carlo Hernandez Ventura, Sammamish, WA (US)

(21) Appl. No.: 19/208,218

(22) Filed: May 14, 2025

(51) Int. Cl. H04W 24/08; H04L 41/14; H04W 72/1263

(52) U.S. Cl. CPC H04W 24/08; H04L 41/14; H04W 72/1263

(57) ABSTRACT

Various embodiments include a system. The system comprises radio circuitry and processing circuitry of an access node. The radio circuitry wirelessly exchanges user data with a user device using a carrier aggregation cell combination. The processing circuitry determines performance metrics for individual ones of a primary cell and one or more secondary cells of the carrier aggregation cell combination used to exchange the user data with the user device. The processing circuitry transfers the performance metrics for the individual ones of the primary cell and the one or more secondary cells to a communication network analytic system.

### TECHNICAL FIELD

Various embodiments of the present technology relate to carrier aggregation, and more specifically, to determining performance metrics for individual cells in carrier aggregation cell combinations.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Carrier aggregation is a type of wireless communication to increase the amount of data exchanged between wireless user devices and RANs. Carrier aggregation utilizes a primary cell and one or more secondary cells. The primary and secondary cells correspond to different radio frequency bands. Radio frequency bands are divided into multiple frequency blocks referred to as component carriers. The component carriers are used to carry the data and signaling between the RAN and user device. In carrier aggregation, multiple component carriers from the primary and secondary cell(s) are grouped to carry data and signaling between the RAN and user device. The grouped component carriers may be from the same radio band or different radio bands. When from the same band, the component carriers may be contiguous (e.g., adjacent Physical Resource Blocks (PRBs)) or non-contiguous (e.g., non-adjacent PRBs).

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for carrier aggregation. Some embodiments comprise a method. The method comprises wirelessly exchanging user data with a user device using a carrier aggregation cell combination. The method further comprises determining performance metrics for individual ones of a primary cell and one or more secondary cells of the carrier aggregation cell combination used to exchange the user data with the user device. The method further comprises transferring the performance metrics for the individual ones of the primary cell and the one or more secondary cells to a communication network analytic system.

Some embodiments comprise a system. The system comprises radio circuitry and processing circuitry of an access node. The radio circuitry wirelessly exchanges user data with a user device using a carrier aggregation cell combination. The processing circuitry determines performance metrics for individual ones of a primary cell and one or more secondary cells of the carrier aggregation cell combination used to exchange the user data with the user device. The processing circuitry transfers the performance metrics for the individual ones of the primary cell and the one or more secondary cells to a communication network analytic system.

Some embodiments comprise one or more non-transitory computer readable storage media having program instructions stored thereon. The program instruction, when executed by a computing system, direct the computing system to perform operations. The operations comprise controlling a radio to wirelessly exchange user data with a user device using a carrier aggregation cell combination. The operations further comprise determining performance metrics for individual ones of a primary cell and one or more secondary cells of the carrier aggregation cell combination used to exchange the user data with the user device. The operations further comprise transferring the performance metrics for the individual ones of the primary cell and the one or more secondary cells to a communication network analytic system.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a communication network to generate individual performance metrics for the primary and secondary cells used in carrier aggregation.

FIG. 2 illustrates an exemplary operation of the communication network to generate individual performance metrics for the primary and secondary cells used in carrier aggregation.

FIG. 3 illustrates another exemplary operation of the communication network to generate individual performance metrics for the primary and secondary cells used in carrier aggregation.

FIG. 4 illustrates an example of a Fifth Generation (5G) communication network to generate individual performance metrics for the primary and secondary cells used in Fifth Generation New Radio Carrier Aggregation (5GNR CA).

FIG. 5 illustrates an example of a User Equipment (UE) in the 5G communication network that generates individual performance metrics for the primary and secondary cells used in 5GNR CA.

FIG. 6 illustrates an example of a 5G Radio Access Network (RAN) in the 5G communication network that generates individual performance metrics for the primary and secondary cells used in 5GNR CA.

FIG. 7 further illustrates the example of the 5G RAN in the 5G communication network that generates individual performance metrics for the primary and secondary cells used in 5GNR CA.

FIG. 8 illustrates an example of a 5G data center in the 5G communication network that generates individual performance metrics for the primary and secondary cells used in 5GNR CA.

FIG. 9 illustrates an exemplary operation of the 5G communication network to generate individual performance metrics for the primary and secondary cells used in 5GNR CA.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

Access nodes in conventional wireless communication networks utilize carrier aggregation to increase the throughput of data sessions with user devices. Carrier aggregation utilizes a primary cell and one or more secondary cells. The primary and secondary cells correspond to different radio frequency bands. Radio frequency bands are divided into multiple frequency blocks referred to as component carriers (e.g., Physical Resource Blocks (PRBs)). The component carriers are used to carry the data and signaling between the access node and user device. In carrier aggregation, the access nodes encode user data and signaling in multiple component carriers from the primary and secondary cell(s) to carry the user data and signaling between the access node and user device. The access nodes generate performance metrics like throughput, data volume, latency, Block Error Rate (BLER), and modulation coding scheme that characterize the operation of the primary and secondary cells. The access nodes report the performance metrics to network analytics systems like Operations Support System (OSS) for exposure to network operators. However, the access nodes provide these metrics as an aggregate to describe the performance both the primary cell and the secondary cell. For example, the access nodes may report the total throughput of a primary cell and secondary cell as opposed to reporting a first throughput for the primary cell and a second throughput for the secondary cell. Reporting the carrier aggregation performance metrics as an aggregate limits the view of network operators of the individual performance of the primary cell and the secondary cells. This restricts the ability of the network operators to identify optimal carrier aggregation combinations and diagnose problems in the access node. This reduces overall network efficiency.

To overcome the above-described problems in conventional wireless communication networks, various embodiments of the present technology relate to generating individual performance metrics for the primary and secondary cells used in carrier aggregation. A wireless access node exchanges user data with a user device using a primary cell and one or more secondary cells of a carrier aggregation cell combination. The access node tracks performance metrics like uplink/downlink throughput, uplink/downlink data volume, uplink/downlink latency, BLER, and modulation coding scheme individually for the primary cell and secondary cells. For example, the access node may determine a first BLER for the primary cell and a second BLER for the secondary cell. The access node reports the individual performance metrics for the primary cell and secondary cell of a network analytic system for exposure to network operators. Generating and reporting individual performance metrics for the primary cell and secondary cells used in carrier aggregation cell combinations improves network operator visibility of the performance of the primary cell and the secondary cells. For example, the one or more individual performance metrics may be used to indicate an amount of data throughput a respective frequency band corresponding to each cell of the primary cell and the one or more secondary cells of the carrier aggregation cell combination contributes to the combined data throughput of the uplink and/or downlink between the carrier aggregation cell combination and the user device. This improves the ability of network operators to identify optimal carrier aggregation cell combinations and to diagnose problems in the access node which improves the overall network efficiency. Now referring to the Figures.

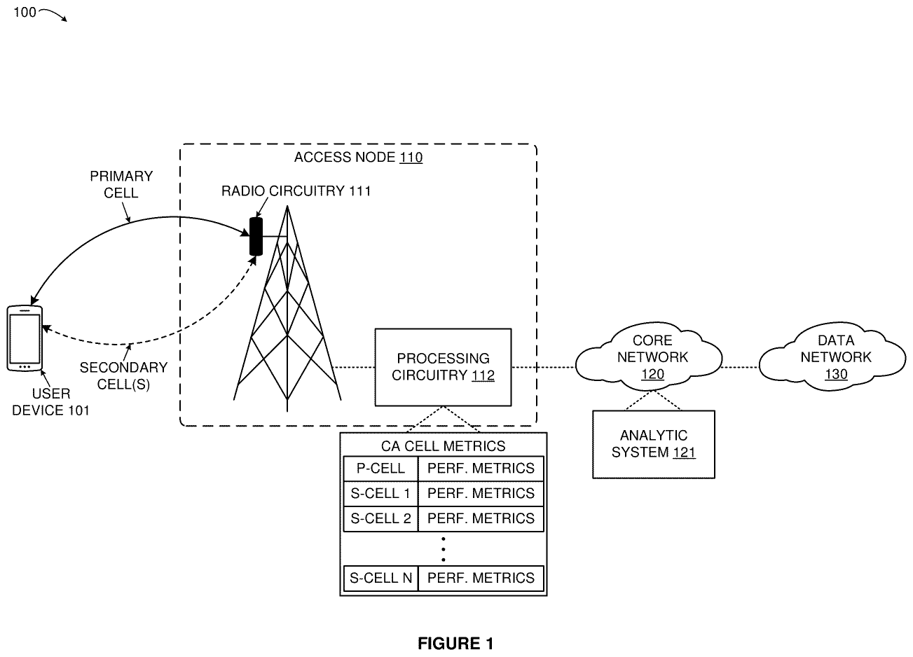

FIG. 1 illustrates communication network 100 to generate individual performance metrics for the primary and secondary cells used in carrier aggregation. Communication network 100 provides services like media-streaming, media-broadcasting, internet-access, voice/video calling, text messaging, online gaming, social media, machine communications, remote device control, and/or some other wireless communications product. Communication network 100 comprises user device 101, access node 110, core network 120, and data network 130. Access node 110 comprises radio circuitry 111 and processing circuitry 112. Core network 120 comprises analytic system 121. In other examples, communication network 100 may comprise additional or different elements than those illustrated in FIG. 1.

Various examples of network operation and configuration are described herein. In some examples, access node 110 serves user device 101. The wireless service provided by access node 110 is organized into cells. The cells correspond to different frequency bands of the bandwidth served by access network 110. Exemplary radio bands include N41, N25, and N71. In carrier aggregation, a device communicates with the access node over multiple cells, one being the primary cell and the other(s) being the secondary cell(s). Radio circuitry 111 wirelessly exchanges user data with user device 101 using a carrier aggregation cell combination. For example, processing circuitry 112 may control radio circuitry 111 to wirelessly deliver signaling and data to user device 101 using the primary cell and one or more secondary cells of the carrier aggregation cell combination. Processing circuitry 112 determines individual performance metrics for the primary cell and secondary cell(s) of the carrier aggregation cell combination used to communication with user device 101. As illustrated in FIG. 1, processing circuitry 112 generates carrier aggregation (CA) cell metrics. The carrier aggregation cell metrics include performance metrics for the primary cell and secondary cells 1-N. Processing circuitry 112 transfers the carrier aggregation cell metrics for delivery to analytic system 121 in core network 120. Processing circuitry 112 may report the carrier aggregation cell metrics continuously, periodically, semi-periodically, randomly, or via another reporting schedule. The carrier aggregation cell metrics may be generated on a per-user device basis (e.g., the raw performance metrics for the primary and secondary cell(s) used by user device 101. Alternatively, the carrier aggregation performance metrics may comprise averaged performance metrics (e.g., average performance of the primary cell and average performance of the secondary cell(s) for some or all of the user devices attached to access node 110). Analytic system 121 receives the carrier aggregation performance metrics and exposes the performance metrics to network operators.

Advantageously, communication network 100 effectively and efficiently generates and reports individual performance metrics for the primary cell and secondary cell(s) used in carrier aggregation combinations. Moreover, by individual tracking performance metrics for the primary cell and secondary cell(s), the ability of network operators to assess the performance of different carrier aggregation combinations and to diagnose technical issues in access nodes is improved.

User device 101 may comprise a phone, computer, vehicle, drone, robot, sensor, or another type of data appliances with wireless and/or wireline communication circuitry. User device 101 and access node 110 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Access node 110 may comprise a tower (e.g., to mount a radio at elevation), another type of mounting structure (e.g., a building), or no mounting structure at all. Access node 110 may comprise a Radio Access Network (RAN) node, Sixth Generation (6G) RAN node, Fifth Generation (5G) RAN node, LTE RAN node, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Although access node 110 is illustrated as comprising a terrestrial access network, in some examples access node 110 may comprise a non-terrestrial (e.g., satellite based) access node. Access node 110 exchanges network signaling and user data with network functions clustered together into core network 120. Access node 110 is connected to core network 120 over one or more backhaul data links. Access node 110 and core network 120 may communicate via edge networks like internet backbone providers, edge computing systems, or another type of edge system to provide the backhaul data and signaling links between access node 110 and core network 120.

Access node 110 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 120. The CUs handle higher wireless network layers like Radio Resource Control (RRC), Service Data Adaption Protocol (SDAP), and Packet Data Convergence Protocol (PDCP). The CUs are coupled to network functions in core network 120. Alternatively, access node 110 may comprise RUs and Baseband Units (BBUs). The BBUs are usually nearby network computers and handle network layers like RRC, SDAP, PDCP, RLC, MAC, and PHY. The BBUs are coupled to network functions in core network 120.

Core network 120 is representative of computing systems that provide wireless data services to user device 101 over access node 110. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access node 110, core network 120, and data network 130 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocol. The computing systems of core network 120 store and execute the network functions/entities to form a control plane and a user plane. Exemplary control plane network functions include Access and Mobility Management Function (AMF) and Session Management Function (SMF), and the like. Exemplary user plane network functions include User Plane Function (UPF) and the like.

Analytic system 121 is representative of a network system to expose analytics characterizing network operation to human operators. Analytic system 121 may comprise an OSS, Orchestration and Management (OAM) system, and the like. Analytic system 121 provides services like network analytics exposure, network configuration management, fault management, performance management, provisioning, inventory management, and security management. Analytic system 121 may interact with the control plane and user plane in core network 120 as well as access node 110.

Analytic system 121 may host one or more machine learning (ML) or artificial intelligence (AI) systems that ingest individual carrier aggregation cell performance data reported by access node 110, the control plane, and/or the user plane to make recommendations, predictions, and/or perform some other type of machine learning or artificial intelligence assisted task. For example, analytic system 121 may host a machine learning model trained to provide carrier aggregation cell combination recommendations and identify problems in access node 110 based on individual primary and secondary cell metrics reported by access node 110. A machine learning model comprises one or more artificial intelligence/machine learning algorithms that are trained based on historical data and/or other types of training data associated with wireless communication networks. A machine learning model may employ one or more machine learning algorithms through which data can be analyzed to identify patterns, make decisions, make predictions, or similarly produce output. Examples of machine learning algorithms that may be employed solely or in conjunction with one another include Large Language Models (LLMs), Three Dimensional (3D) deep leaning models, 3D convolutional neural networks, times series convolutional deep learning, transformers, multi-layer perception, long term short memory, and attention based deep learning model. Other exemplary machine learning algorithms include artificial neural networks, nearest neighbor methods, ensemble random forests, support vector machines, naïve Bayes methods, linear regressions, or similar machine learning techniques or combinations thereof capable of predicting output based on input data.

Data network 130 comprises application servers, gateways, routers, Content Distribution Networks (CNDs) and/or other communication devices to participate in data sessions with user device 101. For example, data network 130 may comprise an application server that hosts the server-side component of a user application executing on user device 101. Data network 130 may be representative of a public data network (e.g., the Internet) or a private data network (e.g., an enterprise network, a government network, a private residential network, etc.). Core network 120 and data network 130 may communicate via links provided by internet backbone providers, edge computing services, and/or other communication services that provide the data links between core network 120 and data network 130.

User device 101 and access node 110 comprise antennas, amplifiers, filters, modulation, analog/digital interfaces, microprocessors, software, memories, transceivers, bus circuitry, and the like. User device 101, access node 110, core network 120, and data network 130 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of communication network 100 as described herein.

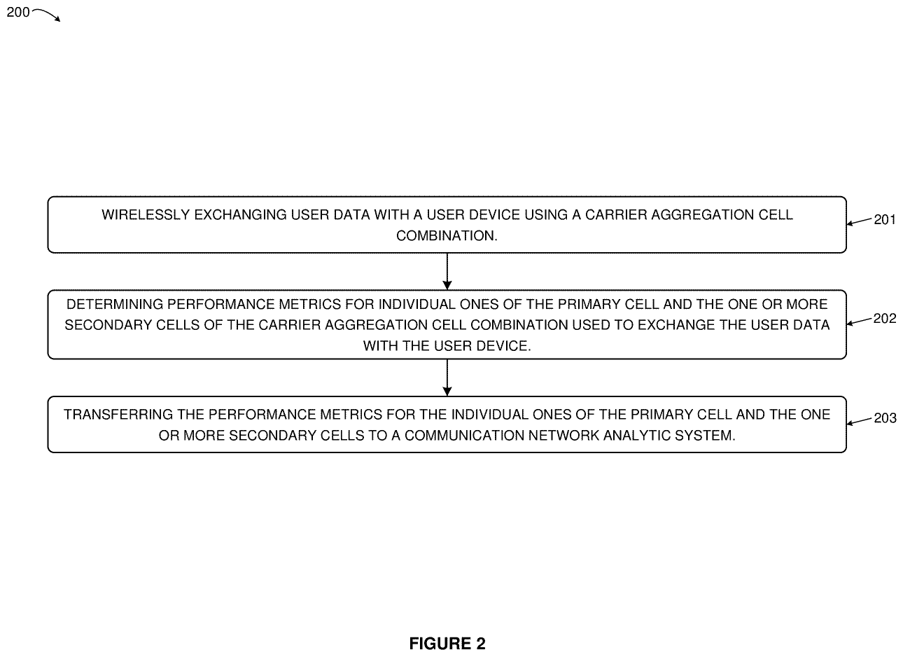

FIG. 2 illustrates process 200. Process 200 comprises an exemplary operation of communication network 100 to generate individual performance metrics for the primary and secondary cells used in carrier aggregation. Process 200 may vary in other examples. The operations of process 200 comprise wirelessly exchanging user data with a user device using a carrier aggregation cell combination (step 201). The operations further comprise determining performance metrics for individual ones of the primary cell and the one or more secondary cells of the carrier aggregation cell combination used to exchange the user data with the user device (step 202). The operations further comprise transferring the performance metrics for the individual ones of the primary cell and the one or more secondary cells to a communication network analytic system (step 203).

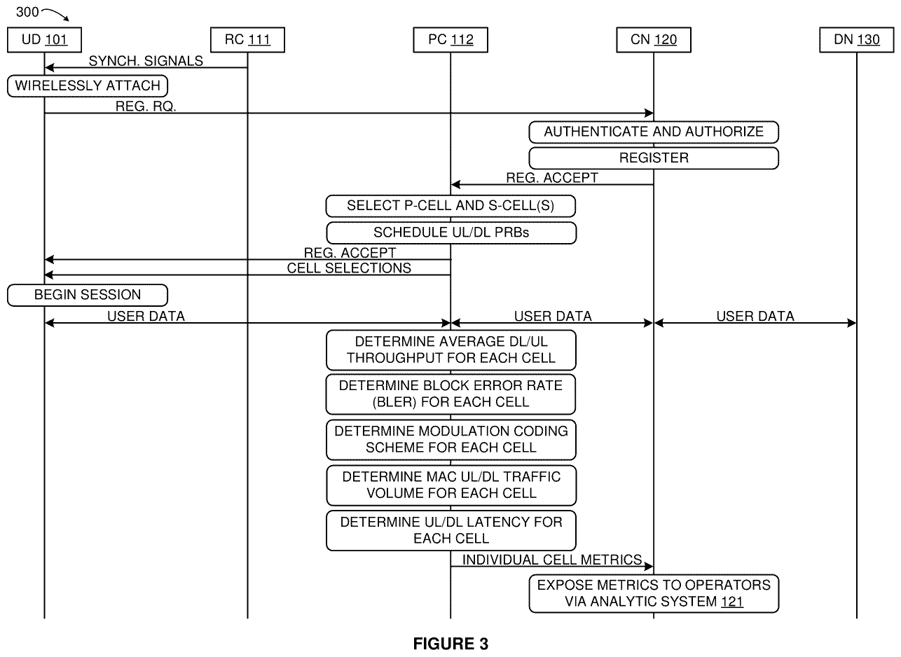

FIG. 3 illustrates process 300. Process 300 comprises an exemplary operation of communication network 100 to generate individual performance metrics for the primary and secondary cells used in carrier aggregation. Process 300 comprises an example of process 200 illustrated in FIG. 2, however process 200 may differ. Process 300 may vary in other examples. In some examples, radio circuitry (RC) 111 broadcasts synchronization (SYNCH.) signals that identify access node 110 and indicate the cells available on access node 110. User device (UD) 101 receives the synchronization signals and measures signal metrics like Received Signal Received Power (RSRP) and Received Signal Received Quality (RSRQ). User device 101 decides to attach to access node 110 and transfers a registration request (REG. RQ.) to core network (CN) 120 via radio circuitry 111 and processing circuitry (PC) 112. The registration request includes information like subscriber Identifier (ID), slice requests, device capabilities, session requests, and the like.

Core network 120 receives the registration request and authenticates the identity of user device 101 and authorizes user device 101 for wireless data service on communication network 100. Responsive to authentication and authorization, core network 120 registers user device 101 and transfers a registration accept message to processing circuitry 112. The registration accept message includes data like device context, Quality-of-Service (QoS), slice selections, network addresses, and the like. Processing circuitry 112 selects a primary cell and one or more secondary cells to serve user device 101. Processing circuitry 112 may select the cells based on radio measurements performed by user device 101, operator defined cell priority, cell loading, user device capabilities, network slice, user device cell location (e.g., near cell, mid cell, far cell, etc.), and the like. Processing circuitry 112 schedules user device 101 to receive/transmit signaling and data in uplink (UL) and downlink (DL) PRBs in the selected cells. Processing circuitry 112 transfers the registration accept message and indicates the cell selections to user device 101 over radio circuitry 111. User device 101 exchanges user data with data network 130 using the PRBs scheduled in the primary and secondary cells over radio circuitry 111, processing circuitry 112, and core network 120.

Processing circuitry 112 derives individual performance metrics for the primary cell and each of the secondary cells used to communicate with user device 101. Processing circuitry 112 determines the uplink and downlink traffic volume for each of the cells and the amount of time it takes to deliver/receive the traffic to/from user device to determine the uplink (UL) and downlink (DL) traffic throughput for each cell. Processing circuitry 112 measures the BLER for each of the cells. Processing circuitry 112 determines the modulation coding scheme for each of the cells. Processing circuitry 112 determines the uplink and downlink MAC traffic volume for each cell. Processing circuitry 112 determines the uplink and downlink traffic latency for each cell. Processing circuitry 112 reports the individual performance metrics for each of the cells to analytic system 121 in core network 120. Analytic system 121 exposes the individual performance metrics for the primary cell and each of the secondary cells to network operators. For example, one or more of the individual performance metrics may be used by analytic system 121 to calculate and/or present an amount of data throughput a respective frequency band corresponding to each cell of a primary cell and one or more secondary cells of the carrier aggregation cell combination contributes to the combined data throughput of the uplink and/or downlink communications between the carrier aggregation cell combination and user device 101. The network operators may use the individual performance metrics to assess carrier aggregation cell combination performance, diagnose problems in access node 110, select cell priorities, and the like.

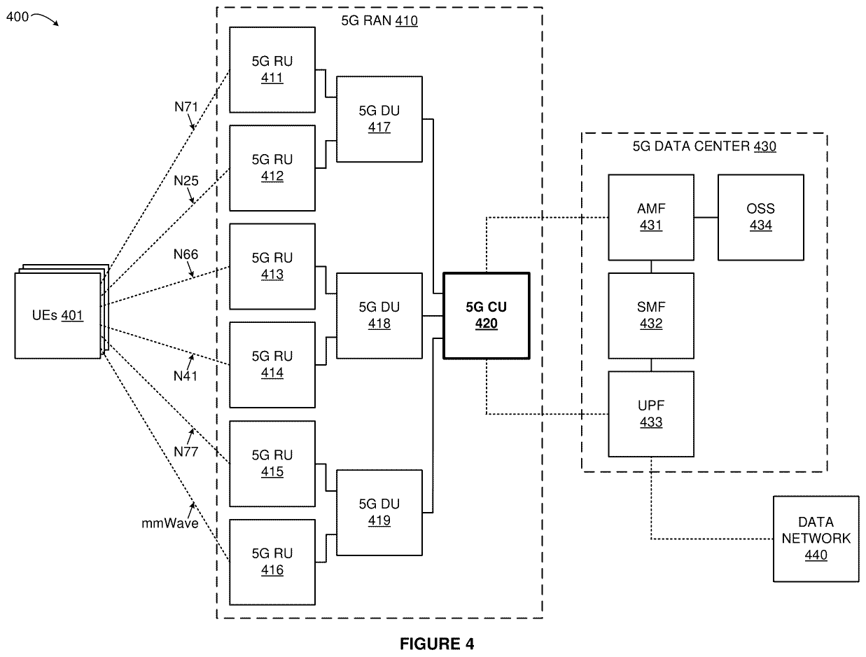

FIG. 4 illustrates 5G communication network 400 to generate individual performance metrics for the primary and secondary cells used in Fifth Generation New Radio Carrier Aggregation (5GNR CA). 5G communication network 400 comprises an example of communication network 100 illustrated in FIG. 1, however communication network 100 may differ. 5G communication network 400 comprises User Equipment (UEs) 401, 5G RAN 410, 5G data center 430, and data network 440. 5G RAN 410 comprises 5G RUs 411-416, 5G DUs 417-419, and 5G CU 420. 5G data center 430 comprises AMF 431, SMF 432, UPF 433, and OSS 434. Other network functions and network entities like Policy Control Function (PCF), Unified Data Management (UDM), Unified Data Registry (UDR), Authentication Server Function (AUSF), Network Slice Selection Function (NSSF), Network Repository Function (NRF), Network Exposure Function (NEF), Application Function (AF), Charging Function (CHF), Home Subscriber System (HSS), Home Subscriber Register (HLR), Short Message Service Function (SMSF), Equipment Identity Register (EIR), and Session Communication Proxy (SCP) are typically present in 5G data center 430 but are omitted for clarity. In other examples, 5G communication network 400 may comprise different or additional elements than those illustrated in FIG. 4.

In some examples, 5G RUs 411-416 correspond to different cells that may be used for carrier aggregation to serve UEs 401. 5G RU 411 provides the N71 band, 5G RU 412 provides the N25 band, 5G RU 413 provides the N66 band, 5G RU 414 provides the N41 band, 5G RU 415 provides the N77 band, and 5G RU 416 provides a mmWave band (e.g., 24 GHz or 36 GHz). Each band comprises contiguous and/or non-contiguous component carriers of various channel bandwidths. 5G CU 420 controls 5G DUs 417-419 to broadcast System Information Blocks (SIBs) from 5G RUs 411-416. The SIBs indicate the bands served by each of 5G RUs 411-416 as well as band priority for their respective frequency bands. For example, the SIB broadcast by RU 411 may identify N71 as the band served by RU 411 and the attachment priority for the N71 band with respect to the other bands served by RUs 412-416.

UEs 401 receive the SIBs and attach to 5G RUs 411-416. UEs 401 transfer registration requests to AMF 431 over 5G RAN 410. The registration requests indicate a registration type, 5G-Global Unique Temporary Identifier (GUTI), Tracking Area Identifier (TAI), UE capabilities, Protocol Data Unit (PDU) session requests, Network Slice Selection Assistance Information (NSSAI) requests, and the like. In response to the registration request, AMF 431 transfers Non-Access Stratum (NAS) identity requests to UEs 401 over 5G RAN 410. UEs 401 indicate their Subscriber Concealed Identifiers (SUCIs) to AMF 431 over 5G RAN 410. AMF 431 interfaces with other network functions like UDM to derive the Subscriber Permanent Identifiers (SUPIs) of UEs 401 and to authenticate the identities of UEs 401. Typically, authentication involves presenting random number challenges to UEs 401 and matching authentication responses from UEs 401 with expected results to verify the identities of UEs 401.

Responsive to the authentication, AMF 431 interfaces with other network functions like UDM and PCF to generate context for UEs 401. The UE context defines the authorized services for UEs 401. To form the context, AMF 431 retrieves access and mobility subscription data, SMF selection subscription data, and UE context in SMF data from the subscriber profiles of UEs 401. The access and mobility subscription data comprises a supported feature list (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list and a list of allowed S-NSSAIs and associated information. The UE context in SMF data comprises PDU session and EPC interworking information. AMF 431 forms the UE context for UEs 401 using the retrieved information.

AMF 431 selects SMF 432 to serve UEs 401 based on the SMF selection data, policy association information received from a PCF, and/or the network slice(s) selected for UEs 401. AMF 431 transfers a list of requested PDU sessions (as received during the registration request), PDU session activation commands, the SUPIs, and typically other information associated with UEs 401 to SMF 432. SMF 432 allocates IP addresses to UEs 401 for the requested PDU sessions and allocates Tunnel Endpoint Identifiers (TEIDs) for the sessions. SMF 432 selects UPF 433 to serve UEs 401 and transfers a session modification request that includes the session endpoint identifiers and TEIDs to UPF 433 to set up the initial PDU sessions for UEs 401. UPF 433 sets up default bearers for UEs 401 with 5G RAN 410. UPF 433 transfers session modification responses to SMF 432 that includes the session endpoint identifiers to confirm bearer setup.

SMF 432 returns PDU session create responses to AMF 431 to confirm session creation. The responses include the updated session context (e.g., allocated IP addresses, TEID, etc.). In response, AMF 431 registers UEs 401 for service on 5G data center 430. AMF 431 generates registration accept messages that include the allocated UE IP addresses, RAN ID, AMBR, Globally Unique AMF ID (GUAMI), PDU session ID, PDU session TEID, allowed NSSAI list, security data, and the like. AMF 431 transfers the registration accept messages to 5G CU 420 to direct 5G RAN 410 to serve UEs 401. 5G CU 420 receives the registration accept messages and initiates secondary cell selection for UEs 401 to use for carrier aggregation. To select the secondary cell(s), 5G CU 420 transfers requests to UEs 401 to trigger A4 measurement events. The A4 measurement event is a handover initiation procedure used by UEs to determine when radio qualities of a neighbor cell exceed a threshold. The A4 measurement event is defined as:

Mn+Ofn+Ocn−Hys>TH (1)

Mn+Ofn+Ocn+Hys<TH (2)

where Mn is the measurement result of the neighboring cell, typically an RSRP or RSRQ value, Ofn and Ocn are neighbor cell frequency offsets, Hys is a hysteresis value to prevent ping-pong behavior, and TH is a threshold. Equation (1) is used to determine when the signal quality of the neighbor cell exceeds a threshold to trigger handover while equation (2) is used to determine when the signal quality of the neighbor cell falls below a threshold to cancel handover.

UEs 401 wirelessly receives the A4 measurement event requests. UEs 401 measure RSRP and/or RSRQ for the secondary cells provided by 5G RAN 410. UEs 401 wirelessly transfer the RSRP/RSRQ measurements, the Physical Cell Identifiers (PCIs), and cell IDs of the secondary cells for delivery to 5G CU 420. 5G CU 420 identifies each secondary cell available to UEs 401 based on the PCIs and cell IDs reported by UEs 401. For example, one of UEs 401 may attach to RU 411 on the N71 cell as the primary cell and report PCIs and cell IDs for the N25 and N66 as available secondary cells. 5G CU 420 compares the RSRP/RSRQ for the identified secondary cells to a threshold to determine candidate cells. 5G CU 420 designates secondary cells with RSRP/RSRQ that exceeded the threshold as candidate cells. In particular, the threshold screens for cells that have sufficient signal strength/quality to serve as secondary cells and excludes secondary cells with insufficient signal strength/quality. 5G CU 420 selects secondary cells for UEs 401 from their respective candidate cells based on factors like operator defined priority, cell loading, UE capabilities, network slice, UE cell location, and the like. 5G CU 420 schedules UEs 401 for transmission/reception in uplink and downlink PRBs on the selected primary and secondary cells.

5G CE 420 transfers RRC reconfiguration messages to UEs 401 to set up data radio bearers. The messages include the registration accept messages, primary/secondary cell IDs, bearer configuration information, network address, and the like. UEs 401 configure their radio bearers using the received information. In response, UEs 401 begins their PDU sessions on 5G communication network 400. UEs 401 exchange user data for their PDU sessions with data network 440 using their respective primary and secondary cells over 5G RAN 410 and UPF 433.

5G CU 420 derives individual performance metrics for the primary cell and each of the secondary cells (e.g., the N71, N25, N66, N41, N77, and mmWave cells) used to communicate with UEs 401. 5G CU 420 determines the uplink and downlink traffic volume for each of the cells and the amount of time it takes to deliver/receive the traffic to/from UEs 401. 5G CU 420 divides the data volume by the amount of time to deliver/receive the data for each cell to determine the uplink and downlink throughput for each cell. 5G CU 420 measures the BLER for each of the cells. 5G CU 420 determines the modulation coding scheme for each of the cells. 5G CU 420 determines the uplink and downlink MAC traffic volume for each cell. 5G CU 420 determines the uplink and downlink latency for each cell. 5G CU 420 reports the individual performance metrics for each of the cells to OSS 434. OSS 434 exposes the individual performance metrics for the primary cell and each of the secondary cells to network operators. The network operators may use the individual performance metrics to assess individual cell performance, 5GNR CA cell combination performance, diagnose problems in access node 110, select cell priorities, and the like.

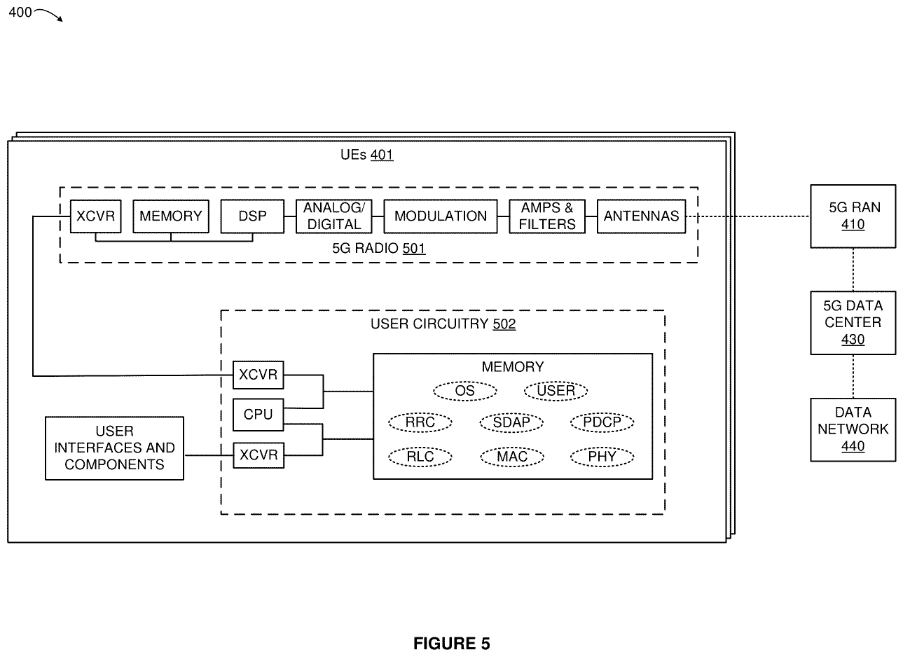

FIG. 5 illustrates UEs 401 in 5G communication network 400. UEs 401 comprise an example of user device 101 illustrated in FIG. 1, although user device 101 may differ. In this example, UEs 401 are referred to in the singular for the sake of clarity. UE 401 comprises 5G radio 501 and user circuitry 502. 5G radio 501 comprises 5GNR antennas, amplifiers, filters, modulation, analog-to-digital interfaces, Digital Signal Processers (DSP), memory, and transceivers (XCVRs) that are coupled over bus circuitry. User circuitry 502 comprises memory, CPU, user interfaces and components, and transceivers that are coupled over bus circuitry.

The memory in user circuitry stores an operating system (OS), user applications (USER), and 5GNR network applications for PHY, MAC, RLC, PDCP, SDAP, and RRC. The antenna in 5G radio 501 is wirelessly coupled to 5G RAN 410 over a 5GNR link. Transceivers in 5G radio 501 are coupled to a transceiver in user circuitry 502. A transceiver in user circuitry 502 is typically coupled to user interfaces and components like displays, controllers, and memory.

In 5G radio 501, the antennas receive wireless signals from 5G RAN 410 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 502 over the transceivers. In user circuitry 502, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 501, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 410 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

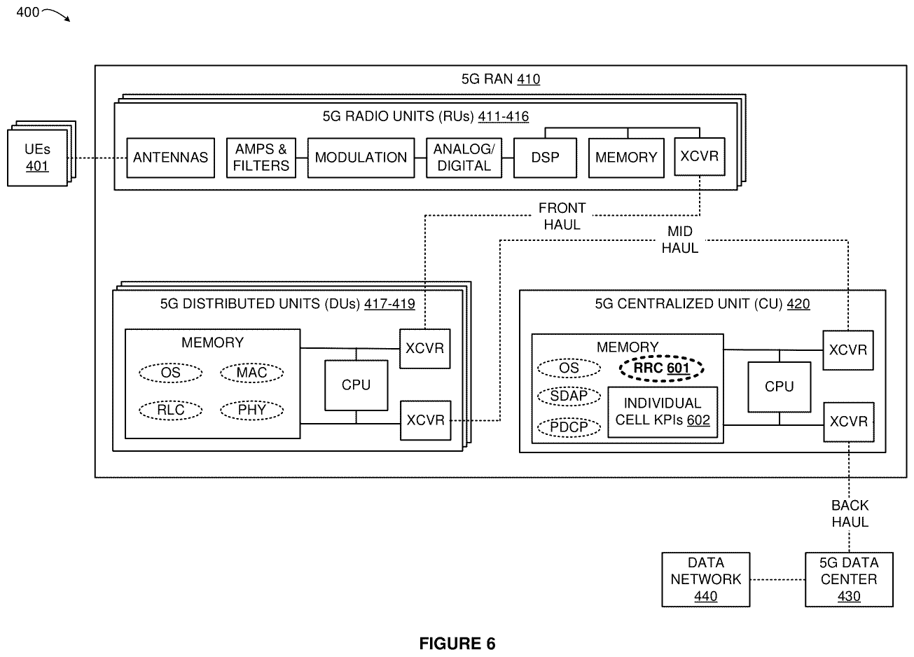

FIG. 6 illustrates 5G RAN 410 in 5G communication network 400. 5G RAN 410 comprises an example of access node 110 illustrated in FIG. 1, however access node 110 may differ. 5G RUs 411-416 comprise 5GNR antennas, amplifiers, filters, modulation, analog-to-digital interfaces, DSP, memory, and transceivers (XCVRs) that are coupled over bus circuitry. UEs 401 are wirelessly coupled to antennas in 5G RUs 411-416 over 5GNR links. Transceivers in 5G RUs 411-416 are coupled to transceivers in 5G DUs 417-419 over fronthaul links like enhanced Common Public Radio Interface (eCPRI). The DSPs in 5G RUs 411-416 execute their operating systems and radio applications to exchange 5GNR signals with UEs 401 and to exchange 5GNR data with 5G DUs 417-419.

For the uplink, the antennas in 5G RUs 411-416 receive wireless signals from UEs 401 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to 5G DUs 417-419 over the transceivers.

For the downlink, the DSPs receive downlink 5GNR symbols from 5G DUs 417-419. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UEs 401 that transport the downlink 5GNR signaling and data. 5G DUs 417-419 comprises memory, CPU, and transceivers that are coupled over bus circuitry. The memory in 5G DUs 417-419 stores operating systems and 5GNR network applications like PHY, MAC, and RLC. 5G CU 420 comprises memory, CPU, and transceivers that are coupled over bus circuitry. The memory in 5G CU 420 stores an operating system, 5GNR network applications like PDCP, SDAP, and RRC 601, and individual cell Key Performance Indicators (KPIs) 602. Individual cell KPIs 602 comprises a table of performance metrics (raw metrics or averaged metrics) for individual ones of the primary and secondary cells provided by 5G RAN 410 to serve UEs 401. Transceivers in 5G DUs 417-419 are coupled to transceivers in 5G RUs 411-416 over front-haul links. Transceivers in 5G DUs 417-419 are coupled to transceivers in 5G CU 420 over mid-haul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC 601 functions include authentication, security, handover control, status reporting, QoS, network broadcasts and pages, network selection, individual cell KPI metric collection, individual cell KPI generation, and individual cell KPI reporting.

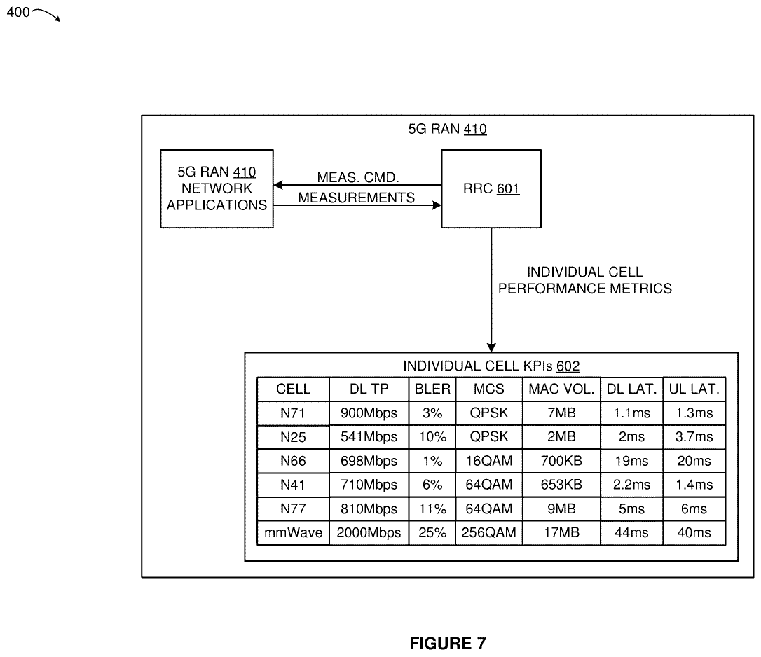

FIG. 7 further illustrates 5G RAN 410 in 5G communication network 400. In some examples RRC 601 transfers measurement commands to the other network applications in 5G RAN 410 (e.g., the SDAP, PDCP, RLCs, MACs, and PHYs) to measure performance metrics of the cells provided by 5G RUs 411-416. RRC 601 communicates with the MACs in 5G DUs 417-419 to determine their total downlink traffic volume and the amount of time it takes for the MACs to clear their downlink data queues for each cell. RRC 601 derives the downlink throughput for the cells based on the total data volume and the time it takes to empty the data queues for each of the cells. RRC 601 loads the downlink throughput (DL TP) and downlink MAC data volumes (MAC VOL.) for each of the cells to individual cell KPIs 602. RRC 601 instructs the MACs and PHYs in 5G DUs 414-419 to measure BLER for each of the cells. The MACs and PHYs determine the ratio of the total number of erroneous transported PRBs to the total number of PRBs and report the ratio as a BLER percentage for each cell to RRC 601. RRC 601 loads the BLER percentages for each of the cells to individual cell KPIs 602. RRC 601 interfaces with the SDAP in 5G CU 420 to determine uplink and downlink latency (DL LAT., UL LAT.) for each cell. The SDAP determines reception time for uplink and downlink user data packets based on transmission timestamps included in the user data packets and reports the uplink and downlink latencies to RRC 601. RRC 601 loads the uplink and downlink latencies for each cell to individual cell KPIs 602. RRC 601 transfers requests to the MACs in 5G DUs 417-419 for the modulation coding schemes selected for each of the cells. The MACs report the modulation coding schemes for the cells to RRC 601. RRC 601 loads the selected modulation coding schemes (MCS) for each cell to individual cell KPIs 602. It should be appreciated that the values of the performance metrics (downlink throughput, BLER, modulation coding scheme, downlink MAC volume, downlink latency, and uplink latency) illustrated in FIG. 7 are illustrative and may differ in other examples.

In some examples, RRC 601 may derive each of the performance metrics for the primary cell and secondary cells used in 5GNR CA combinations to communicate with UEs 401 and load average 5GNR CA performance metrics for the cells to individual cell KPIs 602. For example, two of UEs 401 may use the N71 as a primary cell and the N25 and N66 as secondary cells during a PDU session. RRC 601 may interface with the other network applications in 5G RAN 410 to determine the individual performance metrics for the N71, N25, and N66 for the first one of UEs 401 and the second one of UEs 401. RRC 601 may then average the individual performance metrics for the N71, N25, and N66 determined for both UEs and load the average performance metrics to individual cell KPIs 602.

In some examples, RRC 601 may interface with the other network applications in 5G RAN 410 to determine raw (e.g., unaveraged) performance metrics for each 5GNR CA combination used to communicate with each of UEs 401. RRC 601 may generate individual cell KPIs 602 for each 5GNR CA combination for each of UEs 401. For example, RRC 601 may generate a first one of individual cell KPIs 602 for a first one of UEs 401 using a first 5GNR CA cell combination and may generate a second one of individual cell KPIs 602 for a second one of UEs 401 using a second (or the same) 5GNR CA cell combination. RRC 601 may then report individual cell KPIs 602 for each of UEs 401 and/or each 5GNR CA cell combination to OSS 434.

Once individual cell KPIs 602 are generated, RRC 601 transfers individual cell KPIs 602 as a report for delivery to OSS 434. For example, RRC 601 may transfer a report that includes individual cell KPIs 602 to AMF 431 (or another northbound reporting interface) and AMF 431 may deliver the report to OSS 434. The report may comprise an Application Programming Interface (API) call for OSS 434 that includes individual cell KPIs 602. RRC 601 may generate and transfer the reports periodically. For example, RRC 601 may derive an initial batch of individual cell KPIs 602 over a measurement time period (e.g., one second, ten seconds, one minute, ten minutes, one hour, daily, etc.) and transfer the report after expiration of the measurement time period. Once transferred, RRC 601 may derive a new batch of individual cell KPIs 602 over the measurement time period and transfer the report after expiration of the measurement time period to form a data stream to OSS 434. Alternatively, RRC 601 may stream individual cell KPIs 602 to OSS 434 continuously (e.g., as the metrics are generated).

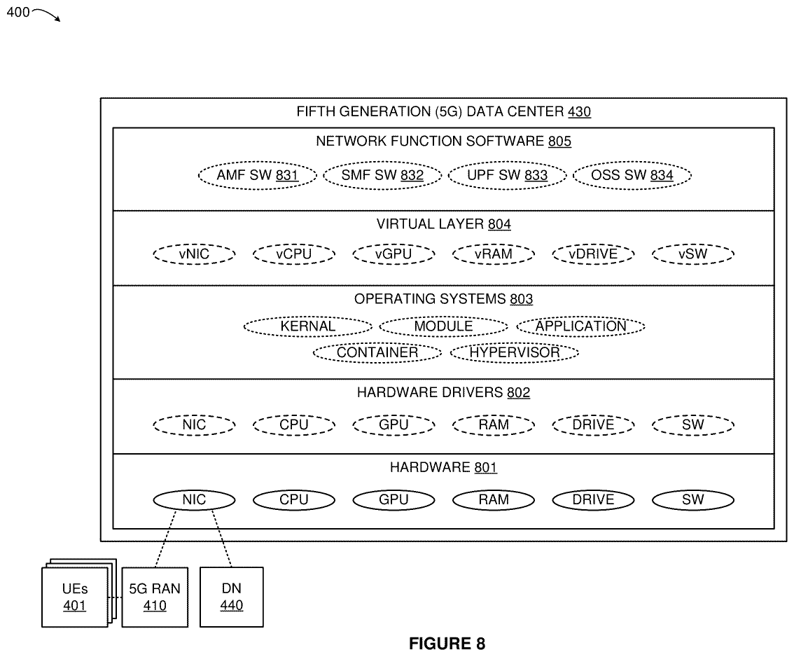

FIG. 8 illustrates 5G data center 430 in 5G communication network 400. 5G data center 430 comprises an example of core network 120 illustrated in FIG. 1, although core network 120 may differ. 5G data center 430 typically comprises a virtualized computing architecture like NFVI, but may comprise another computing architecture like a cloud computing network, a hybrid cloud network, and the like. 5G data center 430 comprises hardware 801, hardware drivers 802, operating systems 803, virtual layer 804, and network function software 805. Hardware 801 comprises Network Interface Cards (NICs), CPU, GPU, RAM, Flash/Disk Drives (DRIVE), and Data Switches (SW). Hardware drivers 802 comprises software that is resident in the NIC, CPU, GPU, RAM, DRIVE, and SW. Operating systems 803 comprise kernels, modules, applications, containers, hypervisors, and the like. Virtual layer 804 comprises vNIC, vCPU, vGPU, vRAM, vDRIVE, and vSW. Network function software 805 comprises AMF Software (SW) 831, SMF SW 832, UPF SW 833, and OSS SW 834. Additional network function software for network functions like AUSF, PCF, UDM, UDR, NSSF, NEF, AF, CHF, HSS, HLR, NRF, SMSF, EIR, and SCP is typically present but is omitted for clarity. 5G data center 430 may be located at a single site or be distributed across multiple geographic locations. The NIC in hardware 801 is coupled to 5G RAN 410, data network (DN) 440, and to external systems (not illustrated). Hardware 801 executes hardware drivers 802, operating systems 803, virtual layer 804, and network function software 805 to form AMF 431, SMF 432, UPF 433, and OSS 434.

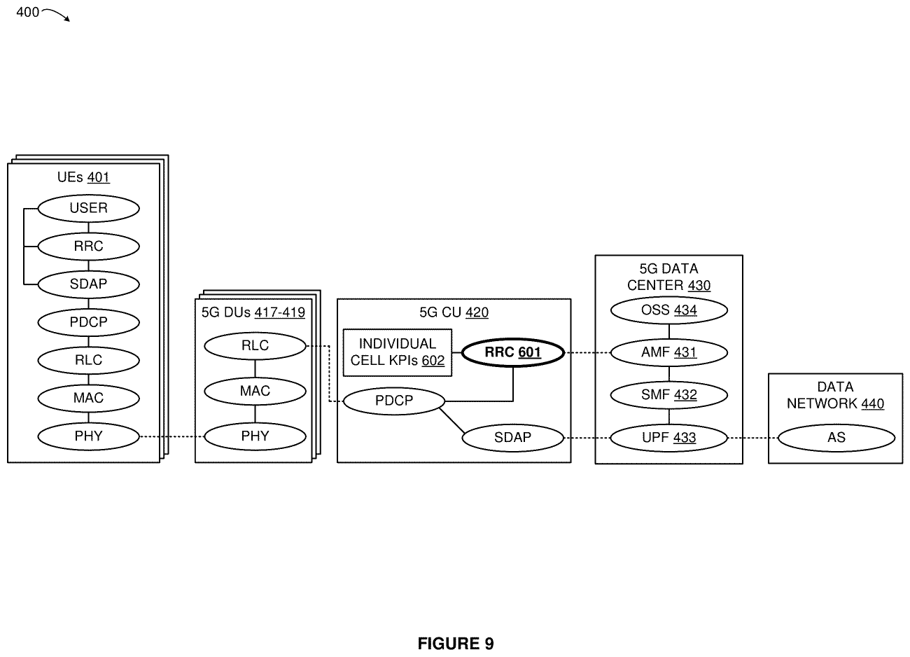

FIG. 9 illustrates an exemplary operation of 5G communication network 400 to generate individual performance metrics for the primary and secondary cells used in 5GNR CA. The exemplary operation illustrated in FIG. 9 comprises an example of process 200 illustrated in FIG. 2 and process 300 illustrated in FIG. 3, however processes 200 and 300 may differ. The exemplary operation illustrated in FIG. 9 may differ in other examples. In some examples, RRC 601 selects 5GNR CA cell combinations (e.g., a primary cell and one or more secondary cells) for UEs 401 in response to receiving registration accept messages for UEs 401 from AMF 431. For example, RRC 601 may trigger A4 measurement events in UEs 401 to generate measurement reports for the cells provided by 5G RUs 411-416 and select the 5GNR CA cell combinations based on the measurement reports. RRC 601 transfers the registration accept messages and indicates the selected primary and secondary cells to the RRCs in UEs 401 over the PDCPs, RLCs, MACs, and PHYs. The RRCs in UEs 401 interface with the lower-layer network applications in UEs 401 to configure their respective primary and secondary cells. Once the cells are configured, the RRCs in UEs 401 direct the user applications and the SDAPs in UEs 401 to begin their PDU sessions. The user applications in UEs 401 execute and generate user data. The SDAPs in UEs 401 exchange the user data using their respective primary and secondary cells with the SDAP in 5G CU 420 over the PDCPs, RLCs, MACs, and PHYs. The SDAP in 5G CU 420 exchanges the user data with UPF 433. UPF 433 exchanges the user data with application servers (AS) in data network 440.

As UEs 401 participate in their PDU sessions using their 5GNR CA cell combinations, RRC 601 interfaces with the other network applications in 5G CU 420 and 5G DUs 417-419 to determine individual cell KPIs 602 for each 5GNR CA cell combination used by each of UEs 401. RRC 601 communicates with the MACs in 5G DUs 417-419 to determine their total downlink traffic and the amount of time it takes for the MACs to clear their downlink data queues for each cell of each 5GNR CA combinations used by UEs 401. RRC 601 derives the downlink throughput for each cell of each 5GNR CA combination used by UEs 401 based on the total data volume and the time it takes to empty the data queues. RRC 601 loads the downlink throughput and downlink MAC data volume for each cell of each 5GNR CA combination used by UEs 401 to individual cell KPIs 602. RRC 601 interfaces with the MACs and PHYs in 5G DUs 414-419 to measure BLER for each cell of each 5GNR CA combination used by UEs 401 and loads the BLER values to individual cell KPIs 602. RRC 601 interfaces with the SDAP in 5G CU 420 and the SDAPs in UEs 401 to determine uplink and downlink latency for each cell of each 5GNR CA combination used by UEs 401 based on transmission timestamps included in the user data packets. RRC 601 loads the uplink and downlink latencies to individual cell KPIs 602. RRC 601 interfaces with the MACs in 5G DUs 417-419 to determine the modulation coding schemes selected for each cell of each 5GNR CA combination used by UEs 401 and loads the modulation coding schemes to individual cell KPIs 602.

RRC 601 generates reports that include individual cell KPIs 602 for each cell of each 5GNR CA combination used by UEs 401 and transfers API calls that include the reports for delivery to OSS 434. OSS 434 hosts a machine learning model trained to recommend 5GNR CA cell combinations, diagnose problems in 5G RAN 410, and/or perform some other machine learning assisted task based on the performance metrics of the individual cells of 5GNR CA cell combinations. It should be appreciated that the amount of data produced by RRC 601 characterizing each cell of each 5GNR CA combination may be voluminous and difficult to parse by human operators. As such, the machine learning model hosted by OSS 434 may be used to synthesize the large amount of data to expedite the review/decision process by the human operators. OSS 434 receives the API calls from RRC 601. OSS 434 generates feature vectors that represent individual cell KPIs 602 and provides the feature vectors to the machine learning model. A feature vector is a numeric data representation (i.e., an n-dimensional vector) interpretable by a machine learning model. The machine learning model ingests the feature vectors and produces machine learning outputs that recommend 5GNR CA cell combinations to improve network performance and that identify technical problems in 5G RAN 410. OSS 434 exposes the machine learning outputs to network operators. For example, the machine learning model may produce an output that identifies 5GNR CA cell combinations that provide higher throughput and lower latency compared to other 5GNR CA cell combinations. For example, the machine learning model may produce an output that identifies a technical problem like lopsided data scheduling (e.g., heavy usage of a first secondary cell and minimal usage of a second secondary cell) for a 5GNR CA cell combination. The human operators may generate and load updates to 5G RAN 410 to prioritize 5GNR CA cell combinations, correct errors, and/or modify some other aspect of 5G RAN 410 based on the output from the machine learning model.

The wireless data network circuitry described above comprises computer hardware and software that form special-purpose network circuitry to generate individual performance metrics for the primary and secondary cells used in carrier aggregation cell combinations. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to generate individual performance metrics for the primary and secondary cells used in carrier aggregation cell combinations.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
wirelessly exchanging user data with a user device using a carrier aggregation cell combination;
determining performance metrics for individual ones of a primary cell and one or more secondary cells of the carrier aggregation cell combination used to exchange the user data with the user device; and
transferring the performance metrics for the individual ones of the primary cell and the one or more secondary cells to a communication network analytic system.

2. The method of claim 1 wherein wirelessly exchanging the user data with the user device using the carrier aggregation cell combination comprises scheduling transmissions in Physical Resource Blocks (PRBs) of the primary cell and the one or more secondary cells and wirelessly exchanging the user data with the user device using the PRBs of the primary cell and the one or more secondary cells based on the scheduling.

3. The method of claim 1 wherein determining the performance metrics for the individual ones of the primary cell and the one or more secondary cells comprises determining at least one of downlink traffic throughput or uplink traffic throughput for the individual ones of the primary cell and the one or more secondary cells.

4. The method of claim 1 wherein determining the performance metrics for the individual ones of the primary cell and the one or more secondary cells comprises determining Block Error Rate (BLER) for the individual ones of the primary cell and the one or more secondary cells.

5. The method of claim 1 wherein determining the performance metrics for the individual ones of the primary cell and the one or more secondary cells comprises determining a modulation coding scheme for the individual ones of the primary cell and the one or more secondary cells.

6. The method of claim 1 wherein determining the performance metrics for the individual ones of the primary cell and the one or more secondary cells comprises determining Media Access Control (MAC) downlink traffic volume for the individual ones of the primary cell and the one or more secondary cells.

7. The method of claim 1 wherein determining the performance metrics for the individual ones of the primary cell and the one or more secondary cells comprises determining Media Access Control (MAC) uplink traffic volume for the individual ones of the primary cell and the one or more secondary cells.

8. The method of claim 1 wherein determining the performance metrics for the individual ones of the primary cell and the one or more secondary cells comprises determining downlink traffic latency for the individual ones of the primary cell and the one or more secondary cells.

9. The method of claim 1 wherein determining the performance metrics for the individual ones of the primary cell and the one or more secondary cells comprises determining uplink traffic latency for the individual ones of the primary cell and the one or more secondary cells.

10. The method of claim 1 wherein the communication network analytic system provides an amount of data throughput a respective band corresponding to each cell of the primary cell and the one or more secondary cells contributes to a combined data throughput of an uplink or a downlink between the carrier aggregation cell combination and the user device based on one or more of the performance metrics.

11. A system comprising:
radio circuitry and processing circuitry of an access node;
the radio circuitry configured to wirelessly exchange user data with a user device using a carrier aggregation cell combination; and
the processing circuitry configured to:
determine performance metrics for individual ones of a primary cell and one or more secondary cells of the carrier aggregation cell combination used to exchange the user data with the user device; and
transfer the performance metrics for the individual ones of the primary cell and the one or more secondary cells to a communication network analytic system.

12. The system of claim 11 wherein:
the processing circuitry is further configured to schedule transmissions in Physical Resource Blocks (PRBs) of the primary cell and the one or more secondary cells; and
the radio circuitry is further configured to wirelessly exchange the user data with the user device using the PRBs of the primary cell and the one or more secondary cells based on the schedule to wirelessly exchange the user data with the user device using the carrier aggregation cell combination.

13. The system of claim 11 wherein the processing circuitry is further configured to determine at least one of downlink traffic throughput or uplink traffic throughput for the individual ones of the primary cell and the one or more secondary cells to determine the performance metrics for the individual ones of the primary cell and the one or more secondary cells.

14. The system of claim 11 wherein the processing circuitry is further configured to determine Block Error Rate (BLER) for the individual ones of the primary cell and the one or more secondary cells to determine the performance metrics for the individual ones of the primary cell and the one or more secondary cells.

15. The system of claim 11 wherein the processing circuitry is further configured to determine a modulation coding scheme for the individual ones of the primary cell and the one or more secondary cells to determine the performance metrics for the individual ones of the primary cell and the one or more secondary cells.

16. The system of claim 11 wherein the processing circuitry is further configured to determine Media Access Control (MAC) uplink and downlink traffic volume for the individual ones of the primary cell and the one or more secondary cells to determine the performance metrics for the individual ones of the primary cell and the one or more secondary cells.

17. The system of claim 11 wherein the processing circuitry is further configured to determine uplink and downlink traffic latency for the individual ones of the primary cell and the one or more secondary cells to determine the performance metrics for the individual ones of the primary cell and the one or more secondary cells.

18. The system of claim 11 wherein the communication network analytic system reports one or more of the performance metrics to a network operator.

19. The system of claim 11 wherein:
the access node comprises a 5GNR gNodeB;
the radio circuitry comprises one or more Fifth Generation (5G) Radio Units (RUs) of the 5GNR gNodeB; and
the processing circuitry comprises one or more 5G Distributed Units (DUs) and a 5G Centralized Unit (CU) of the 5GNR gNodeB.

20. One or more non-transitory computer readable storage media having program instructions stored thereon, wherein the program instructions, when executed by a computing system, direct the computing system to perform operations, the operations comprising:
controlling a radio to wirelessly exchange user data with a user device using a carrier aggregation cell combination;
determining performance metrics for individual ones of a primary cell and one or more secondary cells of the carrier aggregation cell combination used to exchange the user data with the user device; and
transferring the performance metrics for the individual ones of the primary cell and the one or more secondary cells to a communication network analytic system.
